(19) United States
(12) Patent Application Publication
(10) Pub. No.: US 2026/0299240 A1
(43) Pub. Date: Oct. 1, 2026

(54) OPTICAL TERMINAL AND METHOD OF ASSEMBLING COMPONENTS OF FIBER NETWORK

(71) Applicant: Steven E. Kaplan, Elyria, OH (US)

(72) Inventor: Steven E. Kaplan, Elyria, OH (US)

(21) Appl. No.: 19/479,713

(22) PCT Filed: May 3, 2024
(86) PCT No.: PCT/US2024/027773

§ 371 Date: Oct. 28, 2025

Related U.S. Application Data
(60) Provisional application No. 63/463,697, filed on May 3, 2023.

(51) Int. Cl. G02B 6/44

(52) U.S. Cl. CPC G02B 6/4447

(57) ABSTRACT

A fiber optic enclosure can include a housing including a base and a cover that selectively cooperates with the base to form an internal cavity in a first, closed condition, and allow access when the cover is oriented in a second, open position relative to the base. A cable inlet is dimensioned to receive an associated cable therethrough. A split grommet is received in the housing inlet and dimensioned to form a seal between the housing and the associated cable. The enclosure can include at least first and second adapter connectors that each project through the housing and that each include a first portion inside the cavity and a second portion outside the cavity, wherein the second portion of each adapter connector is configured to releasably connect with an associated respective drop cable and wherein the first portion of each adapter connector is configured to releasably connect with an associated optical fiber connector of the associated cable.

### CROSS-REFERENCE TO RELATED APPLICATION

This application claims priority from and benefit of the filing date of U.S. provisional application Ser. No. 63/463,697 filed May 3, 2023, and the entire disclosure of said provisional application is hereby expressly incorporated by reference into the present application.

### FIELD

This disclosure relates to a terminal and telecommunications cable system or assembly, and process of assembling same.

### BACKGROUND

Configuring and assembling a cable, and particularly a fiber-optic cable, to an enclosure or housing or terminal, is well known in the telecommunications industry. Specifically, a customer measures parameters such as the desired length of the cable, and the terminal is shipped from the factory with a predetermined or premeasured length of cable already assembled (i.e., pre-assembled) to the terminal. Thus, a predetermined length of cable or premeasured length of cable is wound on a reel, the cable is secured (sealed) to the terminal so that the reel of cable and pigtails/drop cables are pre-assembled to the terminal to form a terminal cable assembly. The terminal cable assembly is then sent by the telecommunications supplier to the customer in this pre-assembled state so that the final product can be pre-assembled in the field.

This procedure of pre-assembling a premeasured length of cable where the cable is secured to the terminal and then shipped to the customer in a pre-assembled state can be used in a variety of ways. For example, the pre-assembled cable and terminal may be used in aerial, pedestal, or underground applications.

An advantage of this standard practice is that the pre-assembled system can be tested (pre-tested) before shipment of the terminal cable assembly from the supplier.

The pre-assembled terminal cable assembly also has the advantage of using standard length pigtails, i.e., those individual drop lines that extend from respective bulkheads mounted to an associated number of respective ports of the terminal. It is common to provide a terminal having four, eight, or twelve ports, for example, and thus the terminal cable assembly as shipped from the supplier may include up to four, eight, or twelve pigtails joined to the respective ports of the terminal cable assembly. Of course, the precise number of ports and/or pigtails may vary from one manufacturer to another.

There are also a number of disadvantages associated with using the typical terminal cable assembly that is preassembled by the supplier. For example, the supplier is required to maintain a large amount of inventory or different SKUs in order to meet the requirements of its customers.

Another disadvantage of using the conventional terminal cable assembly that is preassembled by the supplier is that usually only one side (end) of a pigtail can be pulled through an associated passage or duct. Because the pigtail is preassembled to the terminal and the assembly then installed in the assembled form, that end of the pigtail that is connected to the terminal cannot be fed through the associated passage or duct, even if it (i) is desirable to feed that particular end through the passage, or (ii) that end is the smaller end of the pigtail that end can be more easily fed through the passage.

Still another disadvantage is that a conventional terminal cable assembly that is preassembled and shipped by the manufacturer to the customer is not made to be repaired. Instead, the pre-assembled assembly is replaced should a problem requiring repair arise.

Yet another disadvantage is that the overall price of the conventional terminal cable assembly increases due to preassembly of components when compared to the pricing of individual components thereof.

A need exists for an improved arrangement that addresses at least one or more of the above-described disadvantages, as well as still other features and benefits.

### SUMMARY

In accordance with one aspect of the present development, a process of installing a fiber optic system is provided, wherein the system can include a fiber optic cable, at least one drop cable, and an enclosure having an inlet dimensioned to receive the fiber optic cable and at least one adapter connector configured to connect to the at least one drop cable. The process can include providing the enclosure having an inlet and at least first and second adapter connectors that each include a first portion located internal to the enclosure and a second portion external to the enclosure; providing the fiber optic cable separated from the enclosure; installing the fiber optic cable in a desired final location; and after the installing step, securing a portion of the fiber optic cable in the enclosure.

The process can further include separating individual optical fibers of the cable and releasably connecting at least one of the optical fibers to the first portion of one of the adapter connectors.

The process can further include connecting at least one drop cable to the second portion of one of the adapter connectors of enclosure external to the enclosure. Each of the optical fibers can include a different color of external jacket, and each adapter connector includes respective different colored indicia associated therewith, and each colored indicia matches one of the different color jackets of the optical fibers.

The process can further include encapsulating a perimeter of the cable with a split grommet that is dimensioned to seal an outer surface of the cable and the housing. The grommet can be compressed about the cable with first and second fasteners on opposite sides of the cable at the inlet to the enclosure. The fasteners can be located axially outward of the grommet along a longitudinal dimension of the cable.

The process can further include connecting first and second housing portions of the enclosure to each other to define an internal cavity in which said first portion of each adapter connector is located. The first and second housing portions can be pivoted relative to each other before connecting the first and second housing portions to each other.

In accordance with another aspect of the present development, a fiber optic enclosure includes a housing including a base and a cover that selectively cooperates with the base to form an internal cavity in a first, closed condition, and allow access when the cover is oriented in a second, open position relative to the base. A cable inlet in the housing is dimensioned to receive an associated cable therethrough. A split grommet is received in the housing inlet and dimensioned to form a seal between the housing and the associated cable extending through the inlet to the cavity.

The housing inlet can include an extension portion that extends outwardly from a perimeter of the housing to provide an extended axial support region for the associated cable. The extension portion can be located axially outside the grommet.

The enclosure can include first and second fasteners received in the extension portion to mechanically clamp an associated cable received on opposite sides thereof.

The enclosure can include at least first and second adapter connectors that each project through the housing and that each include a first portion inside the cavity and a second portion outside the cavity, wherein the second portion of each adapter connector is configured to releasably connect with an associated respective drop cable and wherein the first portion of each adapter connector is configured to releasably connect with an associated optical fiber connector of the associated cable.

The at least first and second adapter connectors can extend parallel to the housing inlet or can extend at an angle between 0 degrees and 90 degrees relative to the housing inlet.

The enclosure can include at least first and second respective internal indicia inside the cavity respectively adjacent the at least first and second adapter connectors to apprise an associated installer to connect an individual optical fiber of the associated cable to a respective particular adapter connector.

The enclosure can further include at least first and second respective external indicia on the housing outside the cavity respectively adjacent the at least first and second adapter connectors to apprise an associated installer to connect an individual associated drop cable to a respective particular adapter connector.

The enclosure can include a hinge interconnecting the base and cover.

Benefits and advantages of the present disclosure will become more apparent from reading and understanding the following detailed description.

### BRIEF DESCRIPTION OF THE DRAWINGS

FIG. 1 is a perspective view of a first embodiment of a closed splice enclosure.

FIG. 2 is a perspective view of the splice enclosure of FIG. 1 shown in an open state.

FIG. 3 is an elevational view of the splice enclosure of FIG. 1.

FIG. 4 is a side view of the splice enclosure of FIG. 1.

FIG. 5 is a perspective view of a second embodiment of a splice enclosure where the base and cover are separate components.

FIG. 6 is a perspective view of yet another embodiment of a splice enclosure.

FIG. 7 is a perspective view of the splice enclosure of FIG. 6 shown in an open state.

FIG. 8 is a perspective view of still another embodiment of a splice enclosure where one or more ports are not in use and are plugged.

FIG. 9 is a perspective view of a cover such as used in the splice enclosure of FIG. 8 where three of the ports are plugged, and a plug assembly of the fourth port is shown in an exploded, perspective view.

FIG. 10 is an exploded perspective view of a plug assembly.

FIG. 11 is an enlarged view of indicia provided adjacent one of the adapters to assist with organizing the fiber connections.

FIG. 12 is a perspective view of still another terminal housing or enclosure.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include” or “may include” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A or/and B” used in the present disclosure include any and all combinations of words enumerated with them. For example, “A or B” or “at least one of A or/and B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.) The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise. Use of dimensions, temperatures, ranges, time, relationships (e.g., “perpendicular”, “parallel”), etc. that either use or do not use further adjectives such as “generally”, “substantially”, “about” or “approximately” in the description or claims are intended to cover both the specific dimension, temperature, range, time, relationship, etc., as well as a range of equivalents (function, way, or result) and only intended to be limited by teachings of the prior art.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

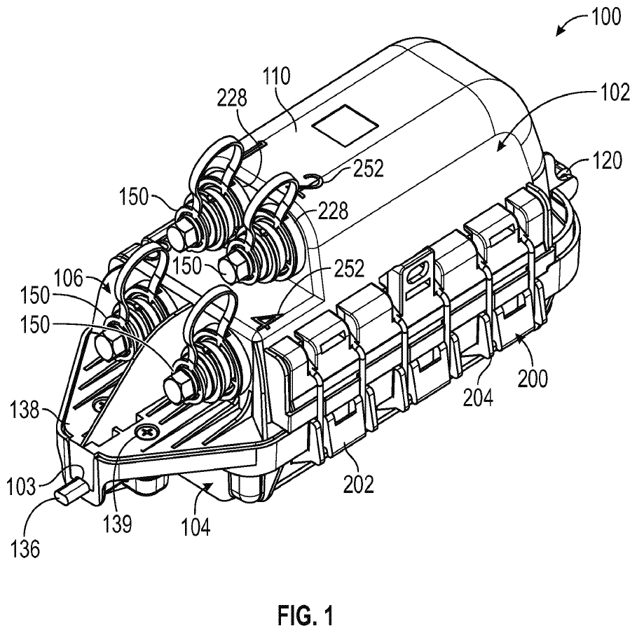

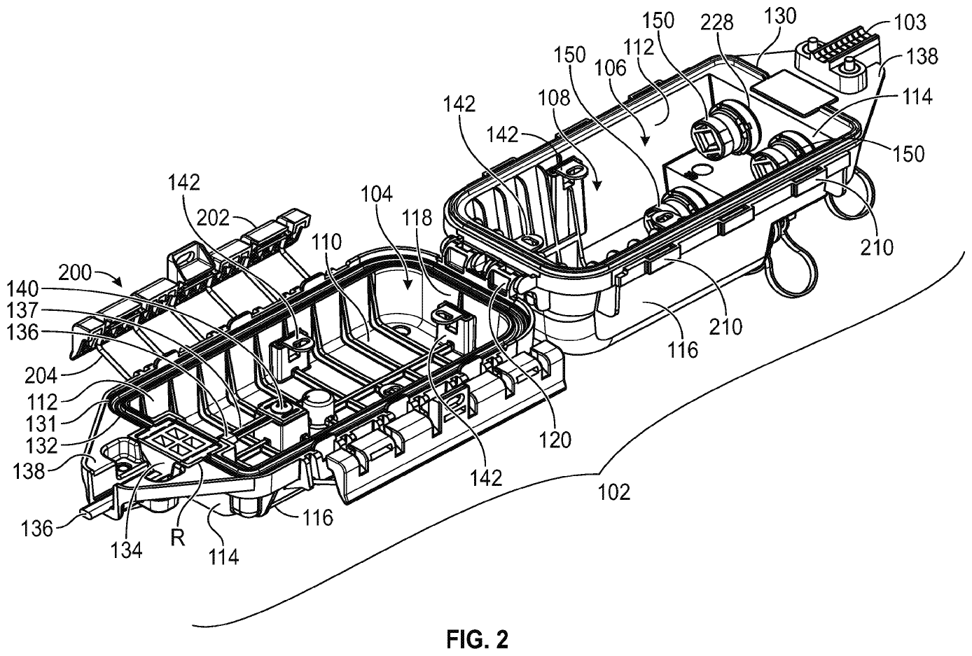

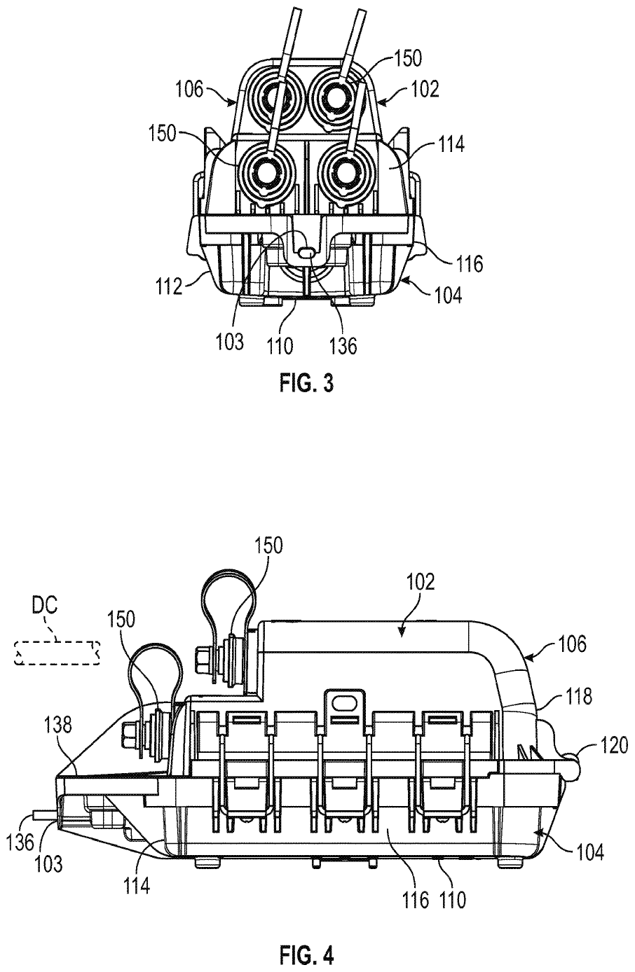

Turning initially to FIGS. 1-4 , there is shown a first embodiment of a sheath splice enclosure 100 having a housing 102 formed of first and second housing portions, namely a first portion or base 104 and a second portion or cover 106. Each housing portion 104, 106 is similarly sized along its perimeter so that when positioned in overlapping, mating relation, the housing portions form an inner cavity 108 (FIG. 2) that is dimensioned to receive cable ends, connectors, wire organizers, etc. Preferably, each housing portion 104, 106 has a rectangular wall portion 110 with first, second, third, and fourth sidewall portions 112, 114, 116, 118 extending generally perpendicular from the wall portion 110 to form the cavity 108. Terminal edges of the sidewall portions 112, 114, 116, 118 of housing portion 104 that are spaced from the rectangular wall portion 110 are located for facing, mating, abutting engagement with the sidewall portions of housing portion 106 in a first or closed condition (FIGS. 1, 3, and 4), and the sidewall portions extend in the same direction from their respective rectangular wall portions when the housing portions are disposed in a second or open position (FIG. 2).

According to the first embodiment, the housing portions 104, 106 are preferably joined along adjacent edge portions by a hinge 120 that allows the housing portions to alternatively adopt the closed configuration (FIGS. 1, 3, and 4) wherein the internal cavity 108 (formed by the facing cavity portions of each housing portion) of the housing 102 can be sealed from the external environment, and an open configuration (FIG. 2) to gain access to the internal cavity. In the preferred embodiment of FIGS. 1-4, the housing portions 104, 106 are assembled together along respective sidewall portions by the hinge 120. Alternatively, hinge 120 could be provided at another location of the housing to allow the housing portions 104, 106 to be selectively oriented in the closed position of FIGS. 1, 3, and 4 and the open position of FIG. 2.

Each housing portion 104, 106 of the terminal or enclosure 100 is preferably a one-piece or integrally molded polymer construction having a suitable thickness and rigidity. Each housing portion 104, 106 may also the include ribs or gussets at strategically placed locations to increase the strength and rigidity of the wall portions 110, 112, 114, 116, 118 of the housing portions and to withstand external environmental conditions. In addition, the wall portions 110, 112, 114, 116, 118 are sufficiently rigid to permit the cavity 108 (when the splice enclosure 100 is in the sealed, closed condition shown in FIGS. 1, 3, and 4) to be pressurized (if needed) and further limit ingress of dirt and/or moisture from the external environment into the cavity. To provide the desired sealing from the environment, at least one of the housing portions 104, 106 preferably includes a resilient seal member or gasket 131. In the preferred arrangement, a groove or recess 130 is provided in one of the housing portions-here, the cover housing portion 106—and preferably the base housing portion 104 likewise includes a groove or recess 132 (FIG. 2). The grooves 130, 132 extend along entire perimeter length of the terminal edges of the sidewall portions 112, 116, 118, and partially along the terminal edge of sidewall portion 114 through which the cable 136 is received. Thus, both of the grooves 130, 132 that receive the gasket 131 preferably have a generally U-shaped conformation, namely, elongated, parallel gasket receiving portions that extend generally perpendicularly from interconnecting portion. The distal ends of the gasket merge into turned-in end regions. The turned-in end regions seal adjacent outer longitudinal edges of incoming/outgoing fiber optic cable(s). The housing 102 includes an inlet 103 by which that cable 136 enters the cavity 108 for operative installation or operative connection of the cable 136 to the enclosure 100. The inlet 103 can include an open recess R located in a sidewall portion 114, and a split input grommet 134 or other non-captive seal is received in the recess R (FIG. 2) in the sidewall portion 114. The split in the grommet 134 is dimensioned to receive the fiber optic cable 136 therethrough in a non-captive manner. When the housing portions 102, 104 are brought into closed engagement when the cover is closed over the base portion (FIGS. 1, 3, and 4), the outer perimeter of the grommet 134 is compressingly engaged, and likewise the grommet compresses around the cable 136 for environmental sealing of the grommet 134 about the cable 136 and for environmental sealing of the grommet 134 to the housing portions 104, 106. As is evident in FIGS. 1, 2, and 4, the housing portions 104,106 include a nose portion 138 that extends axially outward from the sidewall portion 114. The axially extending nose portion 138 may also accommodate an axial portion of the split grommet 134, and advantageously provides an extended length of external support to the cable 136 where the cable enters/exits the terminal housing. In this manner, lateral or side-to-side movement of the cable in the nose portion 138 is limited. The grommet 134 thus encapsulates a perimeter or outer surface of the cable 136 and provides a seal between the perimeter/outer surface of the cable 136 and the housing 102. This arrangement limits moisture and other contaminant ingress around the cable 136 and into the cavity 108 of the terminal housing 102. To add further protection against moisture or dirt ingress and to help secure the cable 136 to the housing 102, a pair of fasteners (e.g., screws 139) may be provided on opposite axial sides of the cable 136 where the cable initially enters into the terminal housing for connecting the housing portions together and compressing the grommet 134 between the housing portions 104, 106 and about the cable 136. In one typical installation, prior to the cable 136 being operatively installed in the enclosure inlet 103 and grommet 134 and as described, the cable 136 has already been placed or installed in the ground or conduit or hung on a pole or other support structure so that the cable 136 is already installed in a desired final location for use of the cable 136. As noted above, once the cable 136 is installed in the inlet 103 and grommet 134, the cable is releasably connected to the housing 102 by securing the cable strength members 137 with the clamp 140 or by use of another suitable clamp within the housing 102.

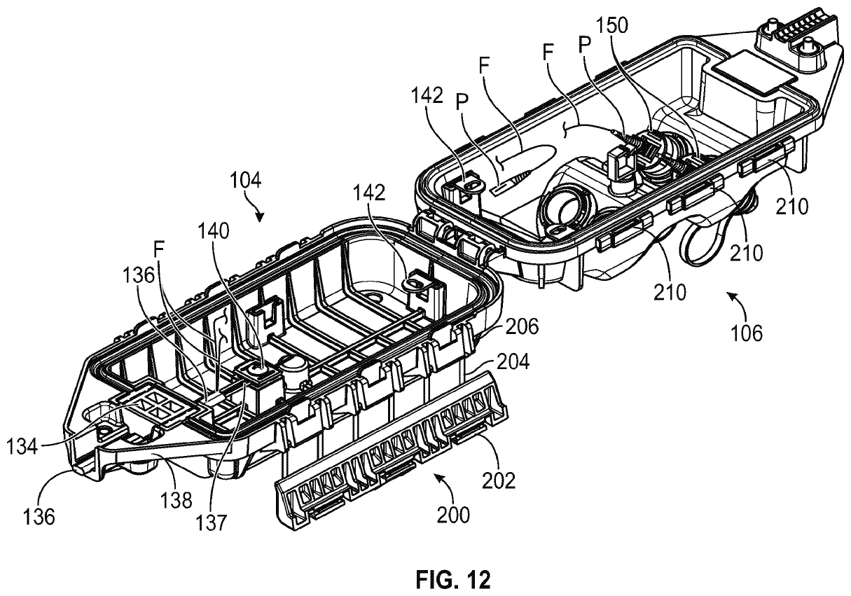

As is well known in the art, the outer jacket of the cable 136 is cut to expose buffer tubes which are likewise removed to access the individual optical fiber lines or optical fibers F (see FIG. 12 which shows one fiber F but typically multiple fibers F are included in the cable 136 such as four fibers or eight fibers) contained in the buffer tubes. One or more strengthening members 137 (FIG. 2) contained in the cable 136 is/are exposed by cutting the outer jacket of the cable, and the strengthening member is secured to a clamp 140 located inside the cavity 108 to prevent pullout of the cable 136 from the terminal housing 102. Further, internal fiber management is accomplished with conventional supplied tie wraps, fiber management clips 142, etc., to provide improved organization and routing of the cable fibers F (FIG. 12) in the terminal housing 102, and to maintain a desired amount of slack in the fibers F that are to be spliced. As shown in FIG. 12, the cable 136 includes one or multiple optical fibers F that are each spliced to one end of a respective pigtail connector P, and an opposite end of the pigtail connector P is fed to an adapter connector (sometimes referred to below simply as an “adapter”) 150 where the connector P can be releasably plugged into or otherwise releasably connected to the adapter connector 150 to operatively mate the fiber F with the adapter connector 150, typically with a snap-fit connection between the pigtail connector P and adapter connector 150 (FIG. 12 also shows one of the fiber pigtail connectors P in an unconnected state). Each adapter 150 (four of which are shown in FIGS. 1-4 with their external dust caps/covers installed) serves as a physical and optical interface between the pigtail connector P of a cable fiber F inside the enclosure cavity 108 and a corresponding external drop cable DC (one shown in FIG. 4) that is outside the cavity 108 and operatively mated with an external portion of the adapter 150 located external to the terminal housing 102 (outside the housing 102 and cavity 108). The adapter 150 is accessible outside of the cavity 108 by way of a port 228 defined in the terminal housing 102 and in which the adapter 150 is operatively installed to extend through a wall of the cover 106 or other part of the housing 102 such that the adapter 150 projects through a wall of the housing 102 in an environmentally sealed manner. The adapter 150 thus includes a first or internal portion located inside the housing cavity 108 for operative releasable connection with a fiber pigtail P of cable 136 and a second or external portion located outside the housing cavity 108 and outside the housing 102 for operative releasable connection with a mating connector of a respective drop cable DC. As is known in the art, the drop cable DC provides a fiber optic connection to a user or other end-point destination. As shown multiple ports 228 such as four (as shown herein) or eight ports 228 are defined in the cover 106 of the housing 102. The adapter 150 and/or drop cables DC that operatively connect to respective adapters 150 outside of the housing 102 may be one of a variety of commercially available components and the present disclosure directed to the splice enclosure 100 and its use need not be limited to a specific type of adapter/connector arrangement.

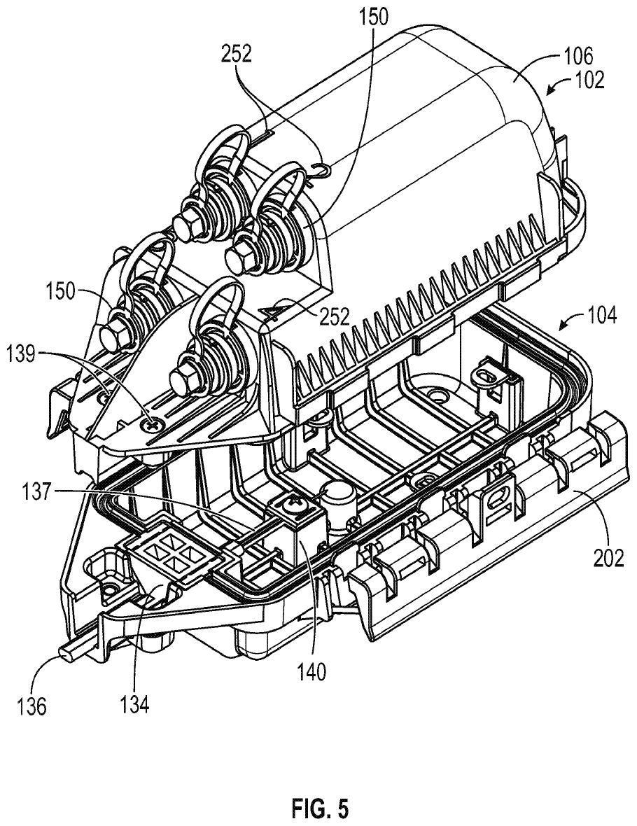

FIG. 5 shows a number of similar features to that of the embodiment of FIGS. 1-4. Notably, the housing portions are not hinged together. In addition, FIGS. 1, 2, 4, and 5 show a preferred form of handle latch assembly 200 for the splice enclosure 100. The handle latch assemblies 200 are preferably positioned in space locations about the perimeter of the housing 102. Each latch assembly 200 includes a latch handle 202 assembled via a retainer wire 204 received in a mounting region recess 206 at one of the perimeter locations of the housing portion. The latch handle 202 is mounted via the wire to provide for an over-center latching action of the latch handle 202 over retaining shoulders 210 provided on the other housing portion.

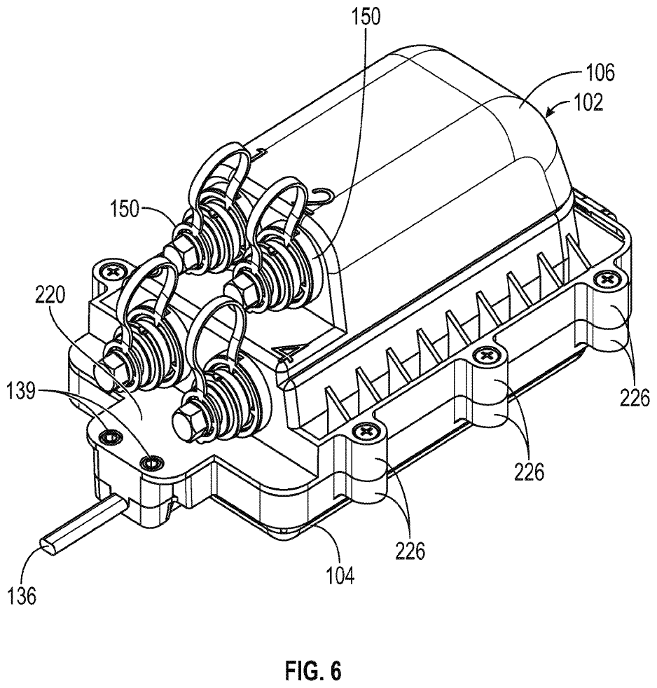

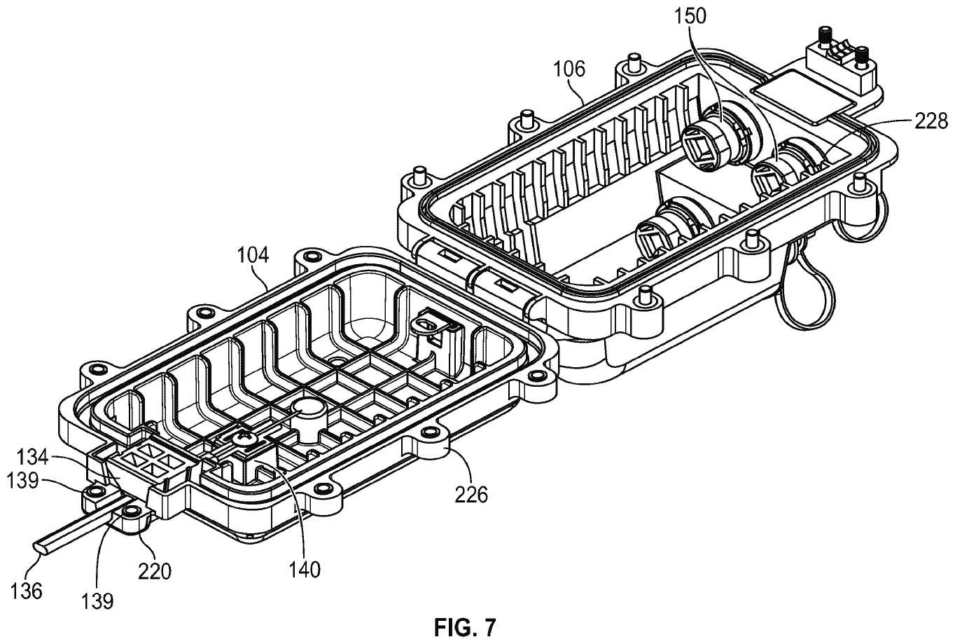

FIGS. 6 and 7 illustrate a slightly modified axially extending nose portion 220. This nose portion 220 reduces the footprint of the nose portion extending from the housing portion while still providing extended axial support for the cable 136 axially outward of the split grommet 134. The nose portion 220 again advantageously provides an extended length of external support to the cable 136 where the cable enters/exits the terminal housing. Side-to-side movement of the cable 136 in the region where the cable enters the nose portion 138 is limited. As a result, there is a reduced prospect of moisture ingress around the cable 136 and into the cavity 108 of the terminal housing. A pair of fasteners (e.g., screws 139) are still preferably provided on opposite axial sides of the cable 136 where the cable initially enters into the terminal housing 102. Further, in FIGS. 6-7 the housing portions 104, 106 are joined together along perimeter regions by aligned gussets 226 that receive a fastener therein to join the housing portions.

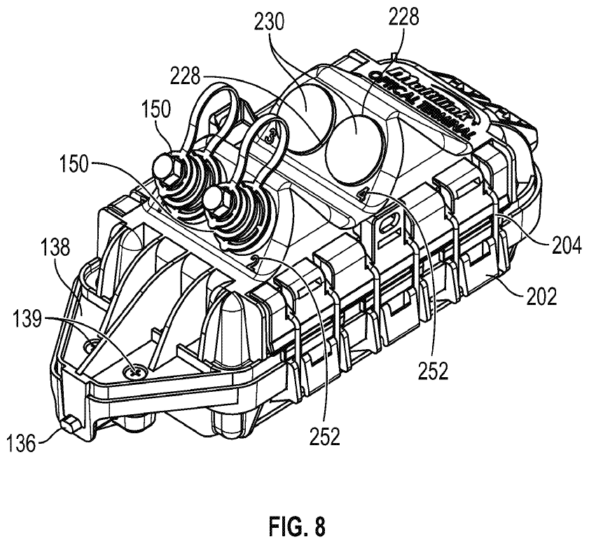

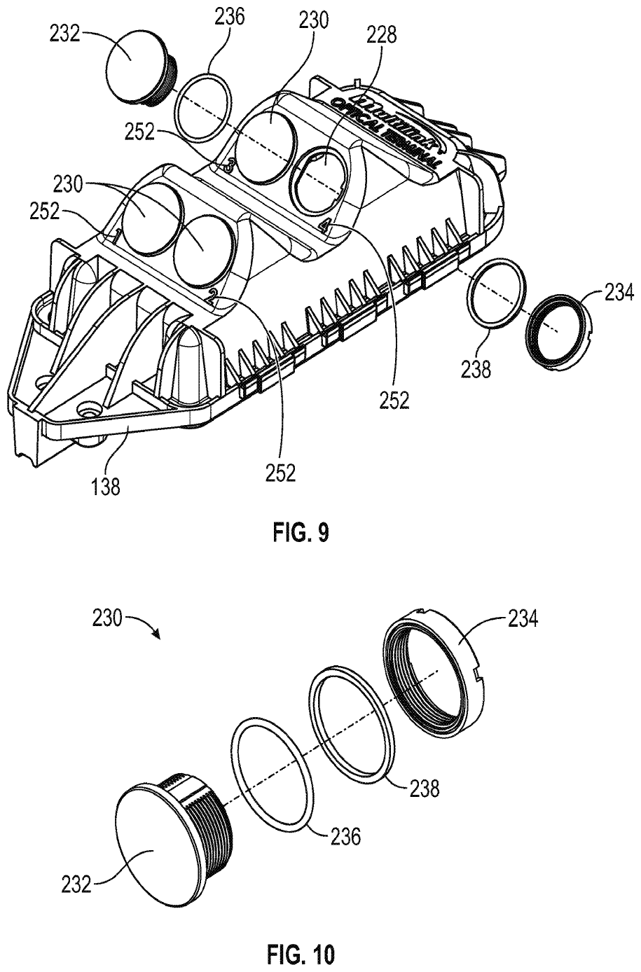

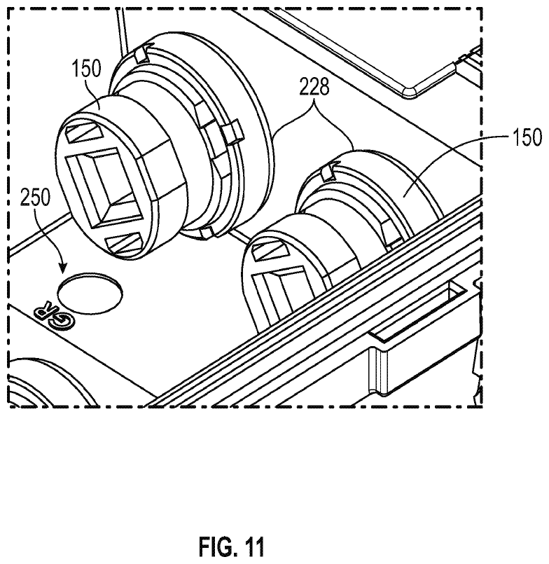

FIGS. 8-10 illustrate that one or more of the housing ports 228 may not be employed in the assembly, i.e., a bulkhead adapter 150 need not be installed in each housing port 228. As shown in FIG. 8, two adapters 150 are operatively installed in respective ports 228, while two ports 228 are unused. As a result, a port plug assembly 230 is preferably used to block ingress into and egress from the housing 102 through the unused port(s) 228. As more particularly shown in FIG. 10, a preferred port plug assembly includes a plug body 232 that is externally threaded over a portion thereof and that threadedly engages an internal thread region of mounting nut 234. An elastomeric seal ring or O-ring 236 and a backing ring 238 complete the assembly. Specifically, and as shown in FIG. 9, the plug body 232 and seal ring 236 are positioned from the outer surface of the enclosure 100, and the external threaded region of the plug body passes through the seal ring, and through the port 228 into the cavity 108. From the inner surface of the housing portion 102, the backing ring 238 receives the threaded portion of the plug body therethrough, and the mounting nut 234 engages the threaded portion of the plug body 232 whereby the seal ring 236 sealingly engages the enclosure 100 around the port 228. FIGS. 8-10 also illustrate that the ports 228 and adapter connectors 150 installed therein can be disposed at an acute angle relative to the longitudinal direction or longitudinal extent of the cable 136, which differs from the parallel arrangement for the ports 228 and adapter connectors 150 as shown in FIGS. 1-7.

FIG. 11 shows that internal indicia 250 (color, numbers, etc.) may be provided on an internal surface of the housing 102 preferably adjacent each port 228, and unique to each port 228. In some instances, the internal indicia 250 may be color coded to match the coating on individual optical fibers in the cable 136. In other instances, the indicia 250 may be numbers or characters to assist the end user with properly locating the connector into the adapter 150. Each port 228 may also include a corresponding number (as shown), letter, color, or other unique external indicia 252 located on (such as by being integrally molded into or applied with paint or a sticker or the like) and visible outside of the enclosure 100 on an external surface of the housing 102. Each port 228 includes a corresponding respective indicia 252 that uniquely identifies the port 228 to a technician or other installer. For each port 228 (and each corresponding adapter 150 installed in the port 228), the internal indicia 250 and external indicia 252 can match or otherwise be coordinated so that an installer can easily determine which fiber pigtail connector P located inside the housing 102 is connected to a particular adapter 150.

Those of ordinary skill in the art will recognize that the housing 102 is non-captive and re-enterable to allow replacement of the housing 102 and/or the cable 136 and/or the bulkhead adapter connectors 150 as needed.

According to the present invention, using any one of the above-described terminals has a number of advantages over the conventional cable and terminal assembly described in the Background as a result of not assembling the cable or pigtails to the terminal prior to shipping the cable assembly to the customer. Particularly, the present terminal can be quickly assembled on site. This permits faster deployment of the terminal by the supplier.

Both warehouse and truck inventory are simplified because there is no need to preassemble components by the manufacturer. As a result, immediate shipping of in-stock components without any configuring of the separate components is required.

Whereas the preassembled terminal would only permit one end of a pigtail to be pulled through a duct because the other end of the pigtail was secured to the terminal, with the present invention, and depending on the size of the duct, either side of the pigtail can be pulled therethrough if the duct is of a sufficient dimension.

Once installation is complete in the field, repairs can be easily made since the components can be easily de-assembled.

Yet another advantage is that the new terminal is compact in size, and less expensive due to reduced labor associated with production, less expensive to repair, and less expensive with respect to installing the overall system or network.

Advantageously, the new process and arrangement is capable of accommodating components from different manufacturers. For example, the final system can be a mix and match of various components, and various components can be easily repaired, for example, one or more of the following components can be easily repaired, e.g., cable, grommet, connector, bulkhead, and terminal housing.

Since this terminal is not preassembled to the cable or pigtails, there is less chance of previous expensive mistakes where, for example, a length of the cable was too short.

Still another advantage is that the new terminal can be applied in all situations, i.e., aerial, pedestal, wall, underground mountings, etc., and the assembly of the cable and pigtails can subsequently be completed in the field.

The installation method of the present system allows the cable to be placed in a trench at the beginning of the installation process and there is no need to re-access underground or re-bury components since connections to the terminal are completed in the field.

The new terminal also accommodates all types of strands or cables, whether the outer surface of the stranded cable is round, flat, etc.

Although there is always a potential of erroneous installation, the method and present system limits potential installation airs when mixing and matching components by providing for keyed connections, or indicia such as color coding to facilitate proper installation.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

Although specific advantages have been enumerated above, various embodiments may include some, none, or all of the enumerated advantages. Although exemplary embodiments are illustrated in the figures and description herein, the principles of the present disclosure may be implemented using any number of techniques, whether currently known or not. Moreover, the operations of the systems and apparatuses disclosed herein may be performed by more, fewer, or other components, and the methods described herein may include more, fewer, or other steps. Additionally, steps may be performed in any suitable order.

To aid the Patent Office and any readers of this application and any resulting patent in interpreting the claims appended hereto, applicants do not intend any of the appended claims or claim elements to invoke 35 USC 112 (f) unless the words “means for” or “step for” are explicitly used in the particular claim.

What is claimed is:

1. A process of installing a fiber optic system wherein the system includes a fiber optic cable, at least one drop cable, and an enclosure having an inlet dimensioned to the fiber optic cable and at least one adapter connector to connect to at least one drop cable, the process comprising:
providing the enclosure having an inlet and at least first and second adapter connectors that each include a first portion located internal to the enclosure and a second portion external to the enclosure;
providing the fiber optic cable separated from the enclosure;
installing the fiber optic cable in a desired final location; and
after the installing step, securing a portion of the fiber optic cable in the enclosure.

2. The process of claim 1 further comprising separating individual optical fibers of the cable and releasably connecting at least one of the optical fibers to the first portion of one of the adapter connectors.

3. The process of claim 2 further comprising connecting at least one drop cable to the second portion of one of the adapter connectors of enclosure external to the enclosure.

4. The process of claim 2 wherein each of the optical fibers includes a different color of external jacket, and each adapter connector includes respective different colored indicia associated therewith, and each colored indicia matches one of the different color jackets of the optical fibers.

5. The process of claim 1 further comprising encapsulating a perimeter of the cable with a split grommet that is dimensioned to seal an outer surface of the cable and the housing.

6. The process of claim 5 further comprising compressing the grommet about the cable with first and second fasteners on opposite sides of the cable at the inlet to the enclosure.

7. The process of claim 6 wherein the fasteners are located axially outward of the grommet along a longitudinal dimension of the cable.

8. The process of claim 1 further comprising separating individual optical fibers of the cable and releasably connecting at least one of the optical fibers to the first portion of one of the adapter connectors.

9. The process of claim 8 further comprising connecting first and second housing portions of the enclosure to each other to define an internal cavity in which said first portion of each adapter connector is located.

10. The process of claim 9, wherein comprising pivoting said first and second housing portions relative to each other before connecting the first and second housing portions to each other.

11. A fiber optic enclosure comprising:
a housing including a base and a cover that selectively cooperates with the base to form an internal cavity in a first, closed condition, and allow access when the cover is oriented in a second, open position relative to the base;
a cable inlet in the housing dimensioned to receive an associated fiber optic cable therethrough; and
a split grommet received in the housing inlet dimensioned to form a seal between the housing and the associated fiber optic cable extending through the inlet to the cavity.

12. The fiber optic enclosure of claim 11 wherein the housing inlet includes an extension portion that extends outwardly from a perimeter of the housing to provide an extended axial support region for the associated cable.

13. The fiber optic enclosure of claim 12 wherein the extension portion is located axially outside the grommet.

14. The fiber optic enclosure of claim 13 further comprising first and second fasteners received in the extension portion to mechanically clamp an associated cable received on opposite sides thereof.

15. The fiber optic enclosure of claim 11 further comprising at least first and second adapter connectors that each project through the housing and that each include a first portion inside the cavity and a second portion outside the cavity, wherein the second portion of each adapter connector is configured to releasably connect with an associated respective drop cable and wherein the first portion of each adapter connector is configured to releasably connect with an associated optical fiber connector of the associated cable.

16. The fiber optic enclosure of claim 15 wherein the at least first and second adapter connectors extend parallel to the housing inlet.

17. The fiber optic enclosure of claim 15 wherein the at least first and second adapter connectors extend at an angle between 0 degrees and 90 degrees relative to the housing inlet.

18. The fiber optic enclosure of claim 15 further comprising at least first and second respective indicia inside the cavity respectively adjacent the at least first and second adapter connectors to apprise an associated installer to connect an individual optical fiber of the associated cable to a respective particular adapter connector.

19. The fiber optic enclosure of claim 18 further comprising at least first and second respective external indicia on the housing outside the cavity respectively adjacent the at least first and second adapter connectors to apprise an associated installer to connect an individual associated drop cable to a respective particular adapter connector.

20. The fiber optic enclosure of claim 11 further comprising a hinge interconnecting the base and cover.
